(19) United States
(12) Patent Application Publication
(10) Pub. No.: US 2019/0129749 A1
(43) Pub. Date: May 2, 2019

(54) AUTOMATED EXTRACTION AND APPLICATION OF CONDITIONAL TASKS

(71) Applicant: Microsoft Technology Licensing, LLC, Redmond, WA (US)

(72) Inventors: Ryen William White, Woodinville, WA (US); Paul Nathan Bennett, Redmond, WA (US); Eric Joel Horvitz, Kirkland, WA (US); Nikrouz Ghotbi, Redmond, WA (US); Jason Henry Portenoy, Seattle, WA (US); Marcello Mendes Hasegawa, Bothell, WA (US); Abhishek Jha, Sammamish, WA (US); Chaitanya Yashwant Modak, Bellevue, WA (US)

(73) Assignee: Microsoft Technology Licensing, LLC, Redmond, WA (US)

(21) Appl. No.: 15/801,142

(22) Filed: Nov. 1, 2017

(51) Int. Cl. G06F 9/48; G06F 9/54; G06F 3/0484

(52) U.S. Cl. CPC G06F 9/4806; G06F 3/04842; G06F 9/543

(57) ABSTRACT

Automatic extraction and application of conditional tasks from content is provided. A conditional task system includes a classifier that is trained and used to identify conditional tasks and to learn appropriate times and methods to engage a user for reminding the user about conditional tasks. The conditional task system includes components for enabling an automated detection of a conditional task, extracting of attributes that characterize a condition associated with the task, using information about the condition to determine how to monitor for satisfaction of the condition, determining when and how to engage the user about the task, and notifying the user at an appropriate time and using an appropriate method when the condition is satisfied.

### BACKGROUND

Computing device users commonly use a variety to tools to manage tasks in their personal and professional lives, such as the usage of calendar applications, to-do lists, or task list applications, setting alarms, or using reminder capabilities provided via a computing device operating system, digital assistant, or application. Such tools typically require users to explicitly create a task item, for example, via a user selection of a new task item command, user input of a task item entry in a to-do or task list, assignment of a task item to another individual, sharing a task item with another individual, integrating a task list from another application or service, input of task details (e.g., start date, due date, reminder information, priority). Further, current tools typically also allow individuals to set task reminders based on conditions, such as time (e.g., remind me to pick up the fruit tray at 6:00 PM), location (e.g., remind me to buy milk when I am at the grocery store), or based on an individual's interaction with a contact (e.g., remind me to talk about project X when Bill calls me), where a reminder notification is provided upon detection of a triggering event (e.g., the date, the time, the user's location, the user's interaction with a contact).

While such tools are useful, conditional tasks embodied as commitments or requests are oftentimes conveyed in interpersonal communications or in other documents. It would be beneficial to users for computing devices to be enabled to identify tasks in interpersonal communications or other documents and to identify and understand conditions in the context of a task (e.g., “I will complete [task] after [condition] has been met”) for enabling reminders at appropriate and relevant times.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to an automated system, method, and computer readable storage device for providing automatic extraction and application of conditional tasks from content. For example, a task conditioned on a set of attributes (e.g., occurrence of an event, action, time, location) can be explicitly encoded in a user's task list or can be expressed in electronic communication media or other content items. Conditional tasks offer an opportunity to intelligently remind users when a trigger condition has been fulfilled. Aspects provide for training a classifier operative or configured to identify conditional tasks and to learn appropriate times and methods to engage a user for reminding the user about conditional tasks. For example, a conditional task system includes components for enabling detecting a conditional task, extracting of attributes that characterize a condition associated with the task action, using information about the condition to determine how to monitor for satisfaction of the condition and to determine when and how to engage the user about the task action, and notifying the user at an appropriate time and in using an appropriate method when the condition is satisfied.

Examples are implemented as a computer process, a computing system, or as an article of manufacture such as a device, computer program product, or computer readable medium. According to an aspect, the computer program product is a computer storage medium readable by a computer system and encoding a computer program of instructions for executing a computer process. The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram showing an example operating environment for implementation of the present disclosure;

FIG. 2 is a block diagram showing an example computing architecture for implementing aspects of the present disclosure;

FIGS. 3A-3B illustrate example use case scenarios;

FIG. 4 is a flow chart showing general stages involved in an example method for providing automatic extraction and application of conditional tasks from content;

FIG. 5 is a block diagram illustrating example physical components of a computing device;

FIGS. 6A and 6B are simplified block diagrams of a mobile computing device; and

FIG. 7 is a simplified block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer readable storage device for providing automatic extraction and application of conditional tasks from content items, such as electronic communications, documents, and the like, where conditional tasks can be expressed as natural language where the meaning of the conditional task may be readily understandable by a person, but may not be readily understood by a computer. As used herein, a conditional task is a natural language phrase or expression that includes a task action and a condition that is to be satisfied prior to the action being taken. Generally, aspects disclosed herein are directed to analyzing a natural language phrase (extracted from a content item), detecting a task comprising a task action that a user intends to take or has been requested to take, determining whether the task action is conditional (i.e., a conditional task) or non-conditional, when the task action is conditional, identifying conditional triggers of the conditional task, monitoring identified conditional triggers for determining when the condition(s) have been satisfied, and determining when and how to engage the user about the task action.

Advantageously, the disclosed aspects enable the benefit of technical effects that include, but are not limited to, increased user interaction performance and an improved user experience. For example, by automatically identifying and extracting conditional tasks from content, such as from task items or electronic communications, users are enabled to have a more efficient user interaction whereby the users do not have to explicitly create tasks or set reminders for conditional tasks. Further, aspects of the present disclosure enable users to be automatically reminded or notified of tasks based on a detection of satisfaction of conditions associated with tasks. Accordingly, users do not have to remember conditions associated with conditional tasks or monitor satisfaction of those conditions for taking action on the tasks.

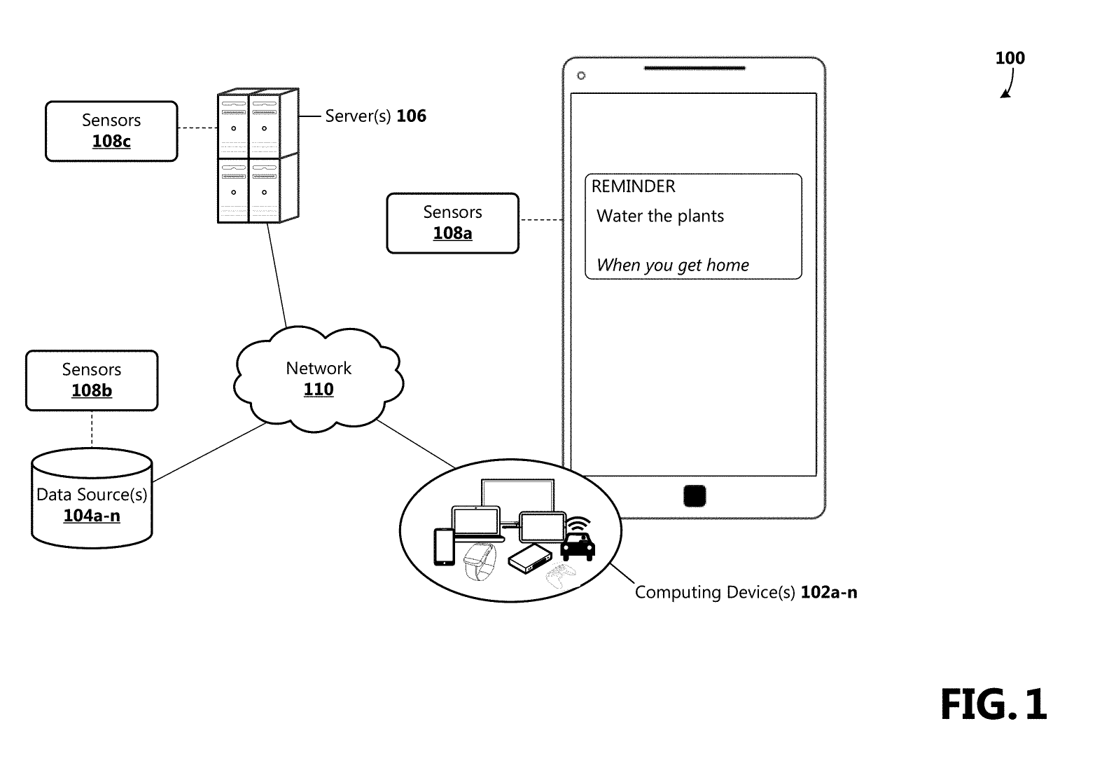

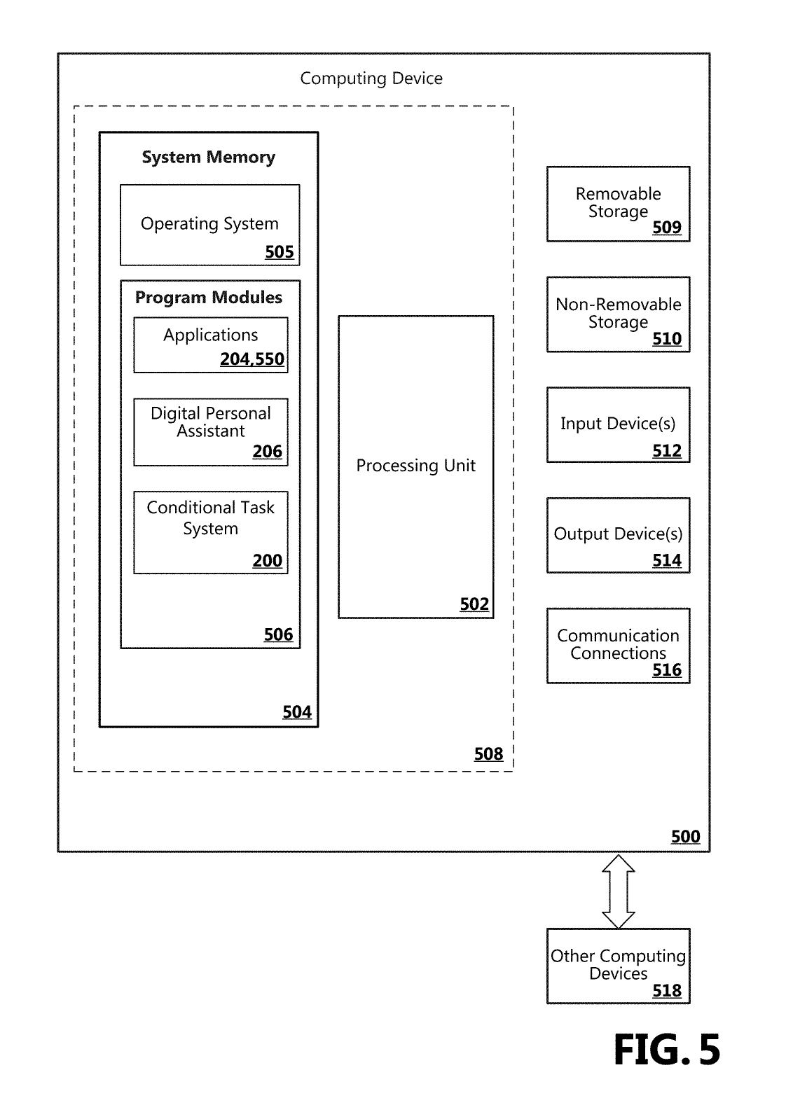

With reference now to FIG. 1, a block diagram is provided showing an example operating environment 100 in which aspects of the present disclosure can be employed. It should be understood that this and other arrangements described herein are provided as examples. Other arrangements and elements can be used in addition to or instead of those shown in FIG. 1. Various functions described herein as being performed by one or more elements or components can be carried out by hardware, firmware, and/or software. For example, some functions can be carried out by a processor executing instructions stored in memory. As illustrated, the example operating environment 100 includes one or more computing devices 102a-n (generally 102), a number of data sources 104a-n (generally 104), at least one server 106, sensors 108a,b,c (generally 108), and a network 110 or a combination of networks. Each of the components illustrated in FIG. 1 can be implemented via any type of computing device, such as the computing devices 500, 600, 705a,b,c described in reference to FIGS. 5, 6A, 6B, and 7. As an example, the one or more computing devices 102 can be one of various types of computing devices, such as tablet computing devices, desktop computers, mobile communication devices, laptop computers, laptop/tablet hybrid computing devices, large screen multi-touch displays, vehicle computing systems, gaming devices, smart televisions, wearable devices, internet of things (IoT) devices, etc.

The components can communicate with each other via a network 110, which can include, without limitation, one or more local area networks (LANs) or wide area networks (WANs). In some examples, the network 110 comprises the Internet and/or a cellular network, amongst any of a variety of possible public or private networks. As should be appreciated, any number of computing devices 102, data sources 104, and servers 106 can be employed within the example operating environment 100 within the scope of the present disclosure. Each can comprise a single device or a plurality of devices cooperating in a distributed environment. For example, the server 106 can be provided via multiple devices arranged in a distributed environment that collectively provide various functionalities described herein. In some examples, other components not shown can be included within the distributed operating environment 100.

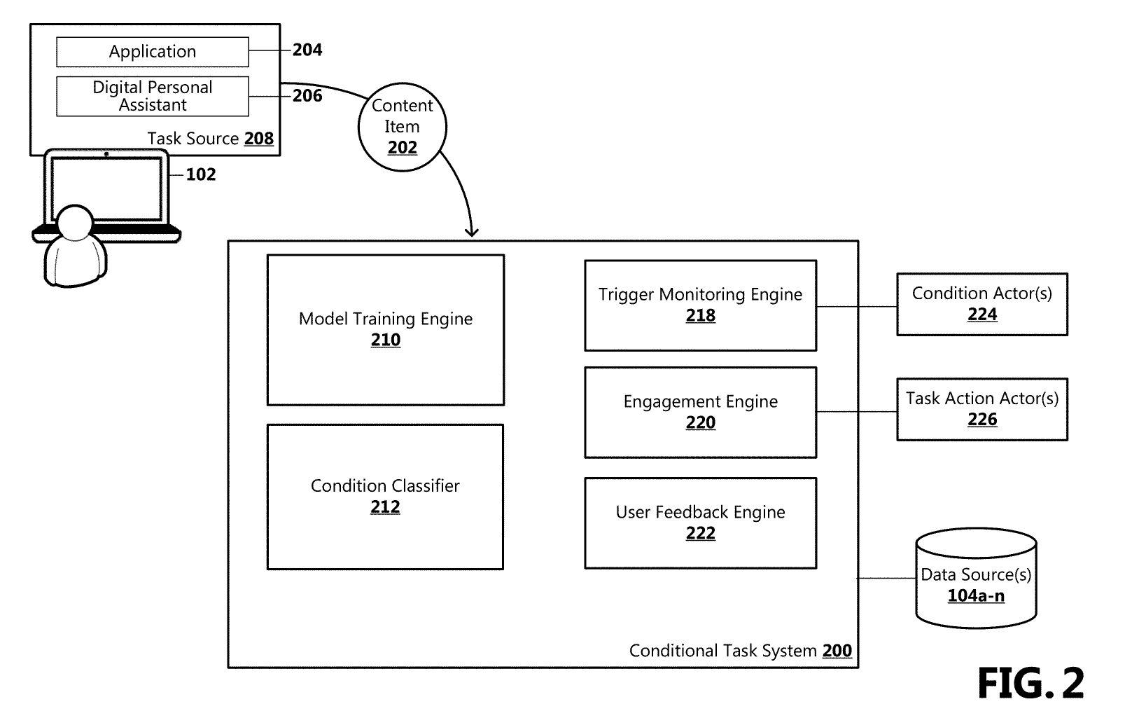

According to an aspect, the one or more data sources 104 can comprise data sources or data systems that are configured to make data available to any of the various components of operating environment 100 or of the example system 200 described below with reference to FIG. 2. In some examples, the one or more data sources 104 are discrete from the one or more computing devices 102 and the at least one server 106. In other examples, the one or more data sources 104 are incorporated or integrated into at least one of the computing devices 102 or servers 106.

According to an aspect, the sensors 108 can include various types of sensors including, but not limited to: cameras, microphones, global positioning systems (GPS), motion sensors, accelerometers, gyroscopes, network signal systems, physiological sensors, and temperature or other environmental factor sensors. For example, sensors 108 can be used to detect data and make the detected data available to other components. Detected data can include, for example, home-sensor data, appliance data, GPS data, vehicle signal data, traffic data, weather data, wearable device data, network data, gyroscope data, accelerometer data, payment or credit card usage data, purchase history data, or other sensor data that can be sensed or otherwise detected by a sensor 108 (or other detector component(s)). According to an aspect, as used herein, the term “context information” describes any information characterizing a situation related to an entity or to an interaction between users, applications, or the surrounding environment.

The disclosed system 200 can optionally include a privacy component that enables the user to opt in or opt out of exposing personal information. The privacy component enables the authorized and secure handling of user information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

The example operating environment 100 can be used to implement one or more of the components of an example conditional task system 200 described in FIG. 2, including components for providing automatic extraction and application of conditional tasks from content. According to an aspect, the terms “conditioned task” or “conditional task” as used herein describe a task action that is conditioned on a set of attributes, such as one or a combination of the occurrence of an event, an action, a person, time, or location. “I will take care of the assignments if Susan sends me the documents” is an example conditional task comprising a task action (take care of the assignments) and a condition (if Susan sends [the user] the documents) on which the task action depends. “Planning to pick up milk unless I'm stuck in traffic and can't get home by 6 pm” is an example of a conditional task that includes two conditions (unless [the user is] stuck in traffic) and (unless [the user] can't get home by 6 pm) in the context of the task action (pick up milk). A conditional task can be embodied as a commitment made by a user (e.g., “I will do [task action] if [condition] is met”) or as a request directed to (and sometimes explicitly agreed to by) a user (e.g., “When [condition] is met, can you [task action]?”).

Aspects of the example conditional task system 200 provide for automated detection of a conditional task, extraction of attributes that characterize a condition associated with a task action, use of information about the condition and context data to determine how to monitor for satisfaction of the condition and to determine when and how to engage the user about the task action, and notification of the user at an appropriate time and in an appropriate way when the condition is satisfied. A block diagram is provided that shows aspects of an example computing system architecture suitable for implementing various aspects of the present disclosure. The conditional task system 200 represents only one example of a suitable computing system architecture. Other arrangements and elements can be used in addition to or instead of the elements shown. As should be appreciated, elements described herein are functional entities that can be implemented as discrete or distributed components, or in conjunction with other components, and in any suitable combination or location.

With reference now to FIG. 2, the example conditional task system 200 includes a model training engine 210, a condition classifier 212, a trigger monitoring engine 218, an engagement engine 220, and a user feedback engine 222. The components of the conditional task system 200 can operate on one or more computing devices 102, servers 106, can be distributed across one or more computing devices 102 and servers 106, or can be implemented in the cloud. In some examples, one or more of the components of the conditional task system 200 are distributed across a network 110 or a combination of networks. In some examples, functions performed by components of the conditional task system 200 are exposed via an API (Application Programming Interface).

According to an aspect, the model training engine 210 is illustrative of a software module, software package, system, or device operative or configured to build the condition classifier 212 to identify conditional tasks. In some examples, one or a combination of machine learning, statistical analysis, behavioral analytics, data mining techniques, and hand tuning are used by the model training engine 210 to train the condition classifier 212. For example, training data comprising tasks that have been labeled as a conditional task or a non-conditional task can be used to train the condition classifier 212 to identify or predict conditional tasks based on learned conditional task characterizing features, such as n-grams in text strings of tasks and other attributes, such as the length of text strings, inclusion of keywords or keyphrases indicative of conditions (e.g., “when,” “once,” “unless,” “after,” “if,” “as soon as,” “provided,” “provided that,” “whenever”), the relative position of placement of conditional keywords or keyphrases (e.g., beginning of a sentence, middle of a sentence), inclusion of a subordinate clause, etc.

According to an aspect, the condition classifier 212 is illustrative of a software module, software package, system, or device operative or configured to detect a task and to identify whether the task is a conditional task or a non-conditional task. For example, the condition classifier 212 receives a content item 202 comprised of one or more natural language phrases, wherein the content item can be an electronic communication item (e.g., email, text message, instant message, meeting request, a voice message transcript), a calendar item, a task item, a document, a meeting transcript, or other content item in which a task can be explicitly encoded or expressed. Content items 202 can be extracted or received from a task source 208 such as an application 204 or a digital personal assistant 206. Additionally, other data, such as metadata and context information can be extracted or received from the task source 208, the computing device 102, and/or from one or more data sources 104. According to an aspect, the other data can include data collected from the one or more sensors 108.

Examples of suitable applications 204 include, but are not limited to, electronic mail applications, messaging applications, calendar applications, reminder applications, to-do list applications, social networking applications, word processing applications, spreadsheet applications, slide presentation applications, note-taking applications, web browser applications, navigation applications, game applications, mobile applications, and the like. In some examples, applications 204 are thick client applications, which are stored locally on the computing device 102. In other examples, applications 204 are thin client applications (i.e., web applications) that reside on a remote server 106 and are accessible over a network 110 or a combination of networks. A thin client application can be hosted in a browser-controlled environment or coded in a browser-supported language and can rely on a common web browser to render the thin client application executable on the computing device 102. In other examples, applications 204 are third-party applications that are operative or configured to employ functions performed by components of the conditional task system 200 via an API.

Consider as an example that a user receives or sends an email (content item 202) via an email application or takes meeting notes (content item 202) via a note-taking application. In some examples, the application 204 can make a call to the condition classifier 212 to parse a content item 202 (e.g., email, email string, meeting notes) and other data (e.g., metadata, context information) to identify tasks expressed in the item, such as a commitment stated by the user (e.g., “I will write the report,” “Bring in the cushions if it's supposed to rain later”) or a request expressly or implicitly agreed upon by the user (e.g., in a received text message: “If you get home before me, fire up the grill” or in a received email: “Can you pick up Ann?” and in a subsequent reply email: “Yes, unless Bob needs me to run the staff meeting.”). In other examples, the application 204 is operative or configured to parse a content item 202 and identify tasks or evoke a third-party application to perform task-identification. In such cases, the application 204 can pass identified tasks and other extracted data (e.g., context information) to the condition classifier 212.

Digital personal assistant functionality can be provided as or by a stand-alone digital personal assistant 206 application, part of an application 204, or part of an operating system of a computing device 102. In some examples, a digital personal assistant 206 employs a natural language user interface (UI) that can receive spoken utterances from a user that are processed with voice or speech recognition technology. For example, the natural language UI can include an internal or external microphone, camera, and various other types of sensors 108. A digital personal assistant 206 can support various functions, which can include interacting with a user (e.g., through the natural language UI or GUIs); performing tasks (e.g., making note of appointments in the user's calendar, sending messages and emails, providing reminders); providing services (e.g., answering questions from the user, mapping directions to a destination, other application or service functionalities that are supported by the digital personal assistant 206); gathering information (e.g., finding information requested by the user about a book or movie, locating the nearest Italian restaurant); operating the computing device 102 (e.g., setting preferences, adjusting screen brightness, turning wireless connections on and off); and various other functions. The functions listed above are not intended to be exhaustive and other functions can be provided by a digital personal assistant 206.

According to an aspect, in identifying a task included in a content item, the condition classifier 212 is operative or configured to perform natural language processing (NLP) on the content item 202 to semantically and/or contextually understand likely intents of a user, such as one or more intents to perform a task action. In some examples, context information is used to resolve task action intents. In some examples, the condition classifier 212 applies natural language processing and machine learning techniques to identify entities, entity properties, and entity relationships with other entities. Further, in some examples, the condition classifier 212 makes a call to another data source 104, such as a search engine or a knowledge graph to resolve entities in a task. For example, a knowledge graph represents entities and properties as nodes, and attributes and relationships between entities as edges, thus providing a structured schematic of entities and their properties and how they relate to the user.

As described above, a task indicates a defined action (task action) that the user commits to take, is requested to take, or is requested to take and implicitly or explicitly agrees to take. In one example, the condition classifier 212 parses a received natural language content item 202 and determines likely task action intents based on words used in the task. For example, the condition classifier 212 can assign a statistical confidence to potential task action intents associated with one or more words in the task, and when statistical confidence meets or exceeds a predetermined threshold, the associated potential task action intent is determined as a likely task action intent. In some examples, the condition classifier 212 is a machine learning model trained on a set of tasks and non-tasks, such that the machined learned model can determine whether a text string includes a commitment to perform a task action or a request to perform a task action. Alternatively, the condition classifier 212 is rules based.

According to one example, the condition classifier 212 is operative or configured to generate constituency parse trees for commitment phrases extracted from content items 202. For example, the constituency trees provide additional layers of information about the grammatical structure of commitment phrases. For each commitment phrase, the condition classifier 212 can traverse the constituency tree and the tags associated with current internal or external nodes can induce transitions over a carefully designed state machine. For example, transitions to specific states can cause associated tokens to be captured as part of a task action or the object of the task action. An action-object pair can define a user's intent. As can be appreciated, this is one example method. Various other methods are possible and are within the scope of the present disclosure.

According to an aspect, when a task is identified, the condition classifier 212 is further operative or configured to determine whether the task includes a task action that is conditioned. That is, a determination as made as to whether the task is a conditioned task or a non-conditional task. According to one example, features of the condition classifier 212 can include n-grams in the text of the tasks and other attributes, such as the length of the text, inclusion of keywords or keyphrases indicative of conditions (e.g., “when,” “once,” “unless,” “after,” “if,” “as soon as,” “provided,” “provided that,” “whenever”), the relative position of placement of conditional keywords or keyphrases (e.g., beginning of a sentence, middle of a sentence), inclusion of a subordinate clause, etc.

According to another example, a machine learning condition classifier 212 can be trained on a set of conditional tasks such that the machine learning model can determine portions of a conditional task. For example, the condition classifier 212 can be operative or configured to interpret a conditional task expression and divide the text phrase into at least one condition and at least one task action that is committed to be performed when the at least one condition is satisfied, and to tag the at least one condition and at least one task action as relating to a condition portion, a task action portion, both a condition portion and a task action portion, neither a condition portion nor a task action portion, or as unresolved. In some examples, determining whether a portion of a conditional task expression is related to a condition portion or a task action portion is based on a statistical confidence (e.g., the condition classifier 112 assigns a statistical confidence identifying a portion as either a condition or a task action, and the statistical confidence meets or exceeds a predetermined threshold). As should be appreciated, this is just one example of a method of extracting conditions from a conditional task. One or a combination of other methods (e.g., regular expression matching to syntactic parse trees) can be used by the condition classifier 212 to extract conditions from a conditional task. Further, additional methods (e.g., dictionary lookups) can be employed to identify different entity types (e.g., people, places, times) in the identified condition portion. According to an aspect, the condition classifier 112 is further operative or configured to use context information to identify conditions.

According to one aspect, the condition classifier 112 is operative or configured to identify an implicit trigger condition based on past user interactions. For example, user interaction data can be collected and analyzed to learn patterns associated with how a particular user, a cohort, or a population acts on certain task actions and to learn on what conditions certain task actions typically depend.

The condition classifier 112 is further operative or configured to identify one or more trigger condition intents and to classify conditions based on identified trigger condition intents. According to an aspect, a condition can be time-based (e.g., before noon, next sundown, early Tuesday morning), location-based (e.g., when I get home, if I go through Atlanta), schedule-based (e.g., in my next meeting with my boss, if I'm available), motion-based (e.g., next time I am traveling greater than 60 mph, unless I'm stuck in traffic), environment-based (e.g., when the forecast for the next day shows rain), person-based (e.g., if I see Bob), event-based (e.g., if Susan sends me the documents, if I don't hear back from you), or any other type of condition. Other trigger condition intents are possible and are within the scope of the present disclosure.

The condition classifier 112 is operative or configured to identify trigger condition intents in a variety of ways. In some examples, a trigger condition intent is based on a specific or explicit keyword, keyphrase, or entity. The condition classifier 112 is operative or configured to identify keywords, keyphrases, or entities in the condition portion of a natural language conditional task by analyzing and tagging the functions of words in the condition portion. For example, the condition portion of a conditional task can be “when I get home.” The condition classifier 112 is operative to identify that the word “home” has a particular meaning. In some examples, context information is used to resolve trigger condition intents.

According to an aspect, the condition classifier 112 is operative or configured to identify explicitly-defined trigger condition intents for classifying conditions. For example, a location-based trigger condition intent can be identified in the example condition “when I arrive at ACME Company Building 44” or the example condition “when I get to Bay County Hospital,” wherein the trigger condition intents are associated with specific or explicitly-defined locations with known addresses and geolocation coordinates. Accordingly, the example conditions can be classified as location-based trigger conditions.

In other examples, a trigger condition intent is based on a semantic keyword, keyphrase, or entity, wherein the meaning of the keyword, keyphrase, or entity is inferred based on context information. According to an aspect, the condition classifier 112 is operative or configured to identify implicitly-implied trigger condition intents. For example, a location-based trigger condition intent can be identified in the example condition “when I get home,” wherein the location-based trigger condition intent is based on an analysis of the word “home” and wherein “home” is a location resolved from user activity (e.g., where the user typically spends the hours from midnight to 6:00 AM). In some examples, the condition classifier 112 is operative or configured to access or request context information and other relevant information for resolving intents or entities (e.g., access contact information for identifying a person or nickname, access calendar information for identifying “free time,” access GPS coordinates for identifying “home” or “work” locations).

According to an aspect, upon identifying trigger condition intents and classifying conditions based on identified trigger condition intents, the condition classifier 112 is further operative or configured to determine a condition semantic frame (e.g., form a construct that identifies intents, condition actors 224, and arguments and the relationship between each for the condition portion) and a task action semantic frame (e.g., form a construct that identifies intents, task action actors 226, and arguments and the relationship between each for the task action portion). In some examples, the condition classifier 112 extracts relevant action-related information and trigger condition-related information. For example, relevant trigger condition-related information can be used to determine one or more trigger conditions or condition arguments and one or more condition actors 224 to monitor for listening for updates or events on the one or more trigger conditions.

In some examples, the condition classifier 112 combines information derived from identifying a conditional task, identifying a trigger condition intent, and classifying a condition to create a conditional semantic frame and an action semantic frame understandable by other components, such as the trigger monitoring engine 218 and/or actors (i.e., condition actors 224 or task action actors 226), which can include applications 204, a digital personal assistant 206, or one or more data sources 104. A semantic frame can specify one or more actors and arguments useful for resolving condition satisfaction (e.g., to examine whether the condition has been met). For example, a condition actor 224 is identified as a system or resource to monitor for identified trigger conditions. The argument(s) can be filled with data using the condition actor 224, which provides the information needed to determine whether the trigger conditions have been satisfied.

As an example, the phrase “when I get home” can be resolved by identifying the condition actor 224 and any arguments for resolving the condition. For example, the conditional statement “when I get home” can be resolved by identifying that the condition is classified as a location-based condition. As such, the condition actor 224 can be determined to be a location or mapping application 204. The arguments can specify the location of the user device and the location of the user's home address. Thus, the phrase “when I get home” can be resolved to the following semantic frame:
CONDITION ACTOR=mapping application;
ARGUMENTS=geographic coordinates for “home”; current location.

As another example, the conditional statement “when I have free time” can be resolved by identifying that the condition is classified as a time-based condition. As such, the condition actor 224 can be determined to be a calendar application 204. For example, an inference can be made, based on information from the user's calendar, that there is a block of time available in the user's schedule between 12:00 PM and 4:00 PM on a specific day. Accordingly, “free time” can be inferred to be between 12:00 PM and 4:00 PM on the specific day. The arguments can specify the open time slots in the user's calendar and the current time. Thus, the phrase “when I have free time” can be resolved to the following semantic frame:
CONDITION ACTOR=calendar application;
ARGUMENTS=open time slots in the user's calendar; the current time.

According to another example, the conditional statement “if Susan sends me the document” can be resolved by identifying that the condition is classified as an event-based condition. As such, the condition actor 224 can be determined to be one or more communication applications 204 (e.g., email application, messaging application). The argument can specify a new message from Susan including an attachment.
CONDITION ACTOR=email application or messaging application;
ARGUMENT=new message from sender “Susan” including a document attachment.

As another example, the conditional statement “if it's raining when I get home” can be resolved by identifying that condition is classified as a location-based condition and an environment-based condition. As such, the condition actors 224 can be determined to be a location or mapping application 204 and a weather application 204. The arguments can specify the location of the user device and the location of the user's home address. Thus, the phrase “if it's raining when I get home” can be resolved to the following semantic frames:
CONDITION ACTOR=mapping application;
ARGUMENTS=geographic coordinates for “home”; current location and
CONDITION ACTOR=weather application;
ARGUMENTS=weather conditions at “home”.

According to an aspect, upon identifying intents, condition actors 224 and arguments and the relationship between each for the condition portion and forming a condition semantic frame, the condition classifier 112 is operative or configured to pass the information to the trigger monitoring engine 218 for monitoring the various condition actors 224. The trigger monitoring engine 218 is illustrative of a software module, software package, system, or device operative or configured to monitor a condition actor 224 and to determine when a trigger condition has been satisfied. In some examples, the trigger monitoring engine 218 passes the condition semantic frame to the condition actor 224 for resolving the argument(s). In other examples, the trigger monitoring engine 218 requests answers to/updates on the argument(s) and determines whether the trigger condition(s) have been satisfied.

Upon making a determination that all trigger conditions for a conditional task have been satisfied, the trigger monitoring engine 218 is operative or configured to pass the information to the engagement engine 220. The engagement engine 220 also receives information from the condition classifier 112 associated with the action portion of the conditional task. For example, the engagement engine 220 can receive the action semantic frame formed by the condition classifier 112 that identifies intents, task action actors 226 and arguments and the relationship between each for the action portion of the conditional task for which the trigger condition has been satisfied as determined by the trigger monitoring engine 218.

According to an aspect, the engagement engine 220 is illustrative of a software module, software package, system, or device operative or configured to engage the user with respect to the conditional task. In some examples, engaging the user comprises reminding the user of the task action that the user committed to take responsive to the condition being satisfied prior to the action being taken. For example, the user can be reminded of the conditional task via a notification, such as a push notification, an email message, a text message, or other type of notification or alert. Information provided to the engagement engine 220 can include information identifying the task action actor 226 and arguments for resolving the task action intent.

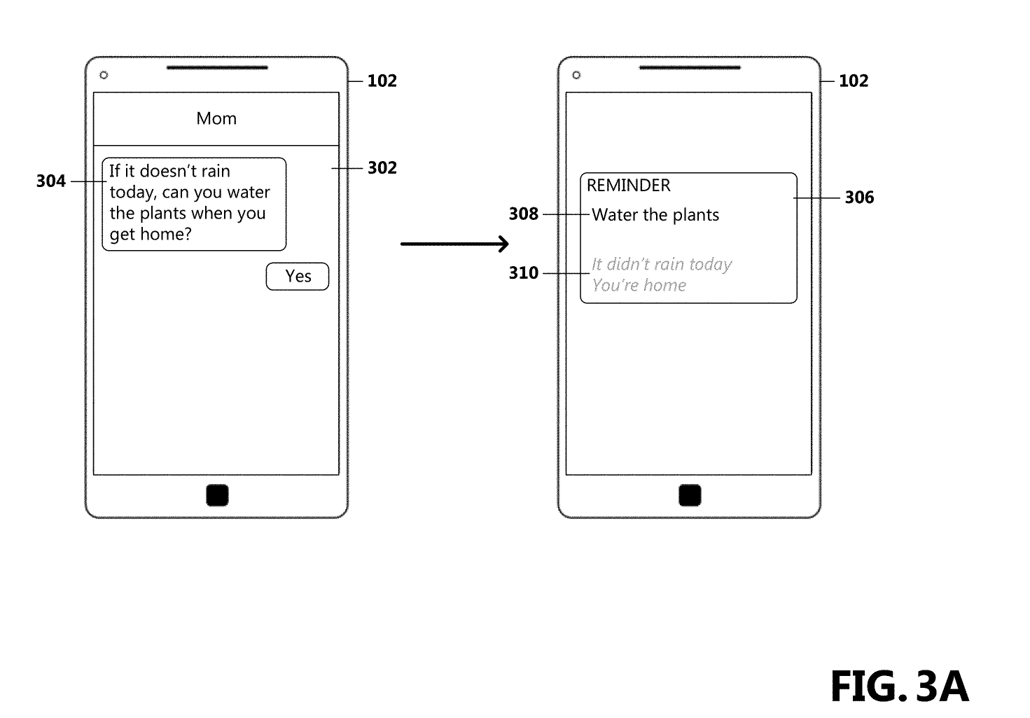

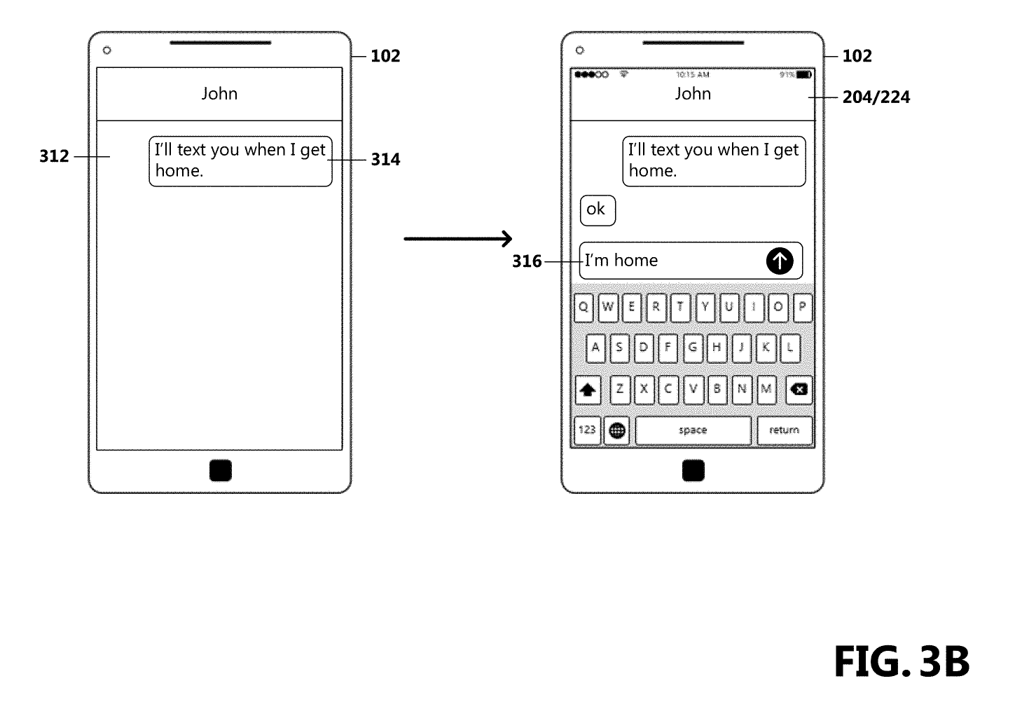

As an example and as illustrated in FIG. 3A, in a text message conversation 302 between the user and the user's mom, the user commits or agrees to a conditional task 304 to water the plants when the user gets home if it doesn't rain today. For the conditional task, the user's action intent can be identified as watering the plants, the task action actor 226 can be determined to be a notification system, and the arguments can be filled with information associated with what to notify the user about. For example, the action portion of the conditional task can be resolved to the following semantic frame:
TASK ACTION ACTOR=notification engine
INTENT=water the plants
ARGUMENTS=“Water the plants”; satisfied conditions.

In the example, the engagement engine 220 is operative or configured to engage with the notification engine (e.g., on the user's computing device 102, integrated with an application 204, integrated with the digital personal assistant 206) to provide a notification 306 to the user “Pick up dry cleaning.” For example, the notification 306 includes a reminder of the task action 308. In some examples and as illustrated, the notification 306 includes the conditions 310 that have been satisfied.

In other examples, engaging the user comprises engaging a task action actor 226 to perform the action or initiate the action on behalf of the user, such as when the action is a computer-implemented task (e.g., set an alarm, send a message, perform a transaction). For example, information provided to the engagement engine 220 can include information identifying the task action actor 226 and arguments for resolving the task action intent. As described above, a task action actor 226 can include an application 204, a digital personal assistant 206, or an operating system of a computing device 102. In some examples, prior to performing or initiating the action on behalf of the user, the engagement engine 220 or the task action actor 226 can seek confirmation from the user. As an example and as illustrated in FIG. 3B, in a text message conversation 312 between the user and a contact John, the user commits or agrees to a conditional task 314 to text John when the user gets home. For the conditional task 314, the user's action intent can be identified as sending a text, the task action actor 226 can be determined to be a text messaging application 204, and the arguments can be filled with information associated with who to send the text to and what text to send. As described above, context information can be used to resolve task action intents, such as to identify the person with whom the user is conversing for resolving who to send the text message to and to determine the person's contact information. For example, the action portion of the conditional task can be resolved to the following semantic frame:
TASK ACTION ACTOR=text messaging application
INTENT=send text to John
ARGUMENTS=John's text number; “I am home.”

In the example, the engagement engine 220 is operative or configured to engage with the text messaging application 204 to initiate a text message 316 to John including the text “I am home.” In some examples, the engagement engine 220 can instruct the task action actor 224 (e.g., the text messaging application 204) to fully execute the task action (e.g., to send the text message).

In other examples, the engagement engine 220 is operative or configured to engage with a task action actor 224 embodied as a task management or task list application 204. For example, the engagement engine 220 can engage with a task management or task list application 204 to generate a list of pending tasks indicating conditional tasks for which the trigger conditions have been determined to be satisfied.

According to an aspect, the engagement engine 220 is further operative or configured to use other data, such as relevant action-related information and/or context information, for determining engagement parameters (e.g., how and when to engage the user). Engagement parameters can be based on identified entities in the action portion of a conditional task (e.g., person, place, time, topic). In some examples, engagement parameters can be based in part on identified task action intent. For example, for a location-based task action, the engagement engine 220 can determine to engage the user with a reminder designed to notify the user of the task action when the user arrives at a particular physical destination. As another example, for a person-based task action, the engagement engine 220 can determine to engage the user with a reminder designed to notify the user in real-time when an email or phone call is received from the person of interest.

According to an aspect, the engagement engine 220 can use relevant action-related information and/or context information to determine whether the user is able to take action on a conditional task at the time when the task's condition(s) have been satisfied. If a determination is made that the user cannot take action on a conditional task at the time that the task's condition(s) have been satisfied, the engagement engine 220 can make a further determination as to an appropriate time to engage the user regarding the conditional task action. As an example, consider the conditional task “call Mark when the scores are posted.” Also consider that the trigger condition of “the scores being posted” is satisfied while the user is in a meeting or while the user is on a conference call. Using knowledge of the user's current status (e.g., in a meeting, on a conference call), the engagement engine 220 may make a determination that although the condition associated with the conditional task has been satisfied, it would be more appropriate or relevant to the user to be engaged, notified, or reminded of the task action of “calling Mark” after the user's meeting or conference call.

In some examples, the engagement engine 220 can determine to present the user with trigger conditions, for example, as a way to identify prerequisites for pending tasks. According to an aspect, the engagement engine 220 is further operative or configured to determine one or more action options to present to the user. For example, when engaging the user with a notification to “call Mark,” the engagement engine 220 can optionally instruct a notification engine to present a button in a graphical user interface (GUI), which when selected, makes a phone call to Mark. In some examples, the additional information used to make the determination of engagement parameters can include user preference data, which can be explicitly set by the user or inferred based on previous user interactions. One example of a user-set engagement parameter based on user preference data includes a user suppressing notifications or automated actions while focusing on a task. Accordingly, the engagement engine 220 can determine the wait to engage the user or to engage a task action actor 224 until the user turns on notifications and automated action functionalities.

According to an aspect, the conditional task system 200 includes a user feedback engine 222 illustrative of a software module, software package, system, or device operative or configured to receive implicit or explicit user feedback. User feedback can include user interaction data or explicit user feedback associated with one or more of an individual user, a cohort, or a population. The feedback engine 222 is operative or configured to determine user preferences based on the feedback. The feedback engine 222 is further operative or configured to pass the user preference information to the model training engine 210 for tuning the condition classifier 212 based on the user feedback.

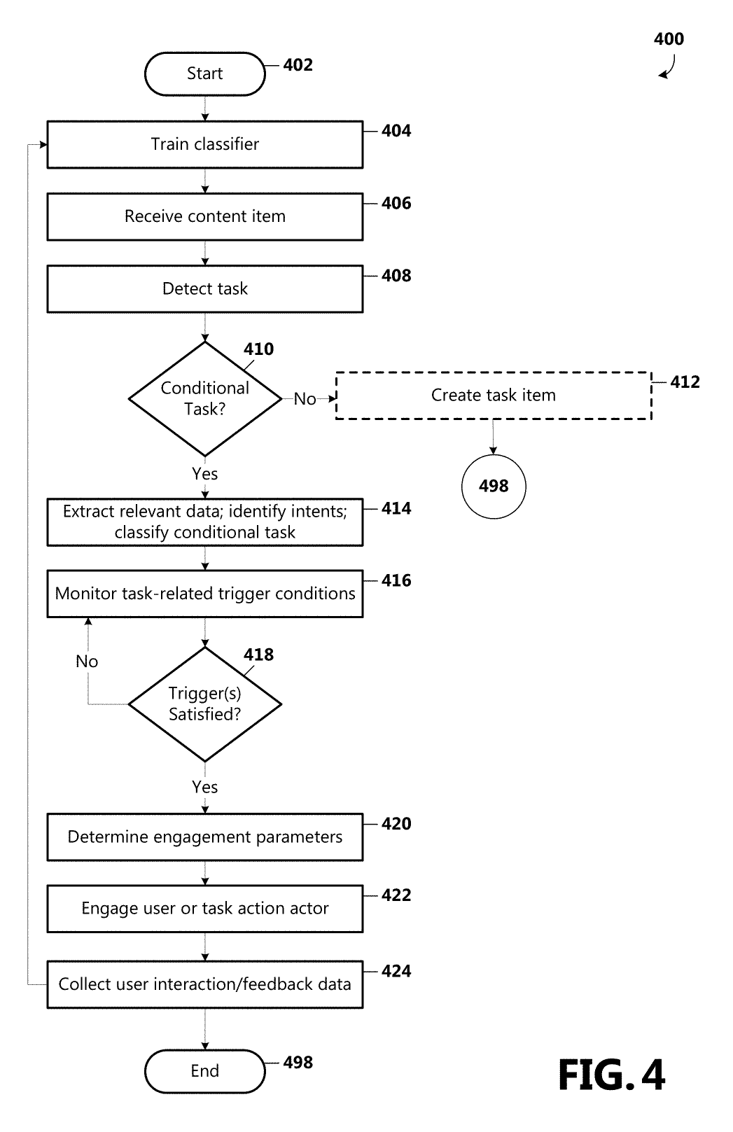

Having described an operating environment 100, an example system 200, and example use case scenarios with respect to FIGS. 1, 2, and 3A-B, FIG. 4 is a flow chart showing general stages involved in an example method 400 for providing automatic extraction and application of conditional tasks from content. With reference now to FIG. 4, the method 400 begins at start OPERATION 402, and proceeds to OPERATION 404, where the condition classifier 212 is trained (e.g., machine learning, hand tuned, or a combination) to identify or predict conditional tasks, to automatically extract action and condition data from a conditional task, and to identify and extract entities relevant to the action and condition.

The method 400 proceeds to OPERATION 406, where the conditional task system 200 receives a content item 202 or at least a portion of a content item comprised of one or more natural language phrases, wherein the content item can be an electronic communication item (e.g., email, text message, instant message, meeting request, a voice message transcript), a calendar item, a task item, a document, a meeting transcript, or other content item in which a task can be explicitly encoded or expressed.

At OPERATION 408, a task is detected. According to an aspect, NLP is performed on the received content item 202 to identify a commitment or request and to semantically or contextually understand likely intents of the user, such as one or more intents to perform a task action.

The method 400 proceeds to DECISION OPERATION 410, where a determination is made as to whether the task is a conditional task or a non-conditional task. For example, the determination can be made based on whether the task includes a task action portion and a condition portion, wherein a task action portion identifies a task action and a condition portion identifies one or more conditions that are to be satisfied prior to executing the task action. As another example, the determination can be made when the task is a conditional based on an implicitly-identified trigger condition according to past user interactions.

When a determination is made that the task is not a conditional task, the method optionally proceeds to OPERATION 412, where a task item is created based on the identified task. When a determination is made that the task is a conditional task, the method proceeds to OPERATION 414, where relevant data is extracted, trigger condition intents and action condition intents are identified, the conditional task is classified based on the identified intents, and a condition semantic frame and a task action semantic frame are developed. For example, in identifying condition intents and classifying the condition (e.g., time-based, location-based, schedule-based, motion-based, environment-based, person-based, event-based), one or more trigger conditions occurring on one or more condition actors 224 are identified for monitoring.

The method 400 proceeds to OPERATION 416, where the identified one or more condition actors 224 are monitored for determining if the one or more trigger conditions have been satisfied (OPERATION 418). If a determination is made that the trigger conditions associated with the conditional task have not been satisfied, the method 400 returns to OPERATION 416 for continued monitoring.

When a determination is made that the trigger conditions associated with the conditional task have been satisfied, the method 400 proceeds to OPERATION 420, where engagement parameters are determined. In some examples, engagement parameters are determined at OPERATION 414. For example, engagement parameters define when and how to engage the user. At OPERATION 420, a determination can be made as to whether it is appropriate to engage the user at the current moment based on context information, user preferences, or other information. If a determination is made not to engage the user at the current moment, a determination can be made as to an appropriate time to engage the user.

The method 400 proceeds to OPERATION 422, where engagement occurs based on the task action semantic frame. In some examples, engagement comprises engaging an task action actor 226 to perform the task action or initiate the task action on behalf of the user, such as when the task action is a computer-implemented task (e.g., set an alarm, send a message, perform a transaction). In other examples, engagement comprises engaging an task action actor 226 embodied as a notification engine to provide a notification 306 to the user reminding the user of the task action. The method 400 ends at END OPERATION 498.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are used for practicing aspects, described herein.

FIG. 5 is a block diagram illustrating physical components (i.e., hardware) of a computing device 500 with which examples of the present disclosure may be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550,204. According to an aspect, the system memory 504 includes the digital personal assistant 206. According to another aspect, the system memory 504 includes one or more components of the conditional task system 200. The operating system 505, for example, is suitable for controlling the operation of the computing device 500. Furthermore, aspects are practiced in conjunction with a graphics library, other operating systems, or any other application program, and is not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

As stated above, according to an aspect, a number of program modules and data files are stored in the system memory 504. While executing on the processing unit 502, the program modules 506 (e.g., application 204, digital personal assistant 206, one or more components of the conditional task system 200) perform processes including, but not limited to, one or more of the stages of the method 400 illustrated in FIG. 4. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit using a microprocessor, or on a single chip containing electronic elements or microprocessors. For example, aspects are practiced via a system-on-a-chip (SOC) where each or many of the components illustrated in FIG. 5 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media do not include a carrier wave or other propagated data signal.

According to an aspect, communication media are embodied by computer readable instructions, data structures, program modules, or other data in a modulated data signal, such as a carrier wave or other transport mechanism, and includes any information delivery medium. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

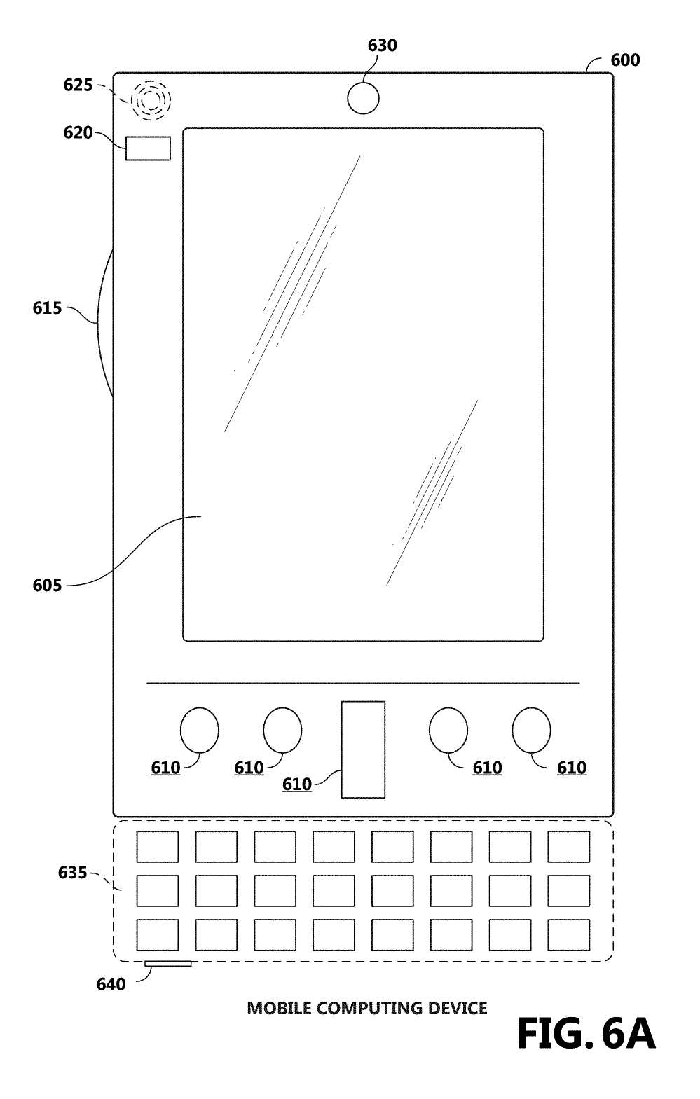

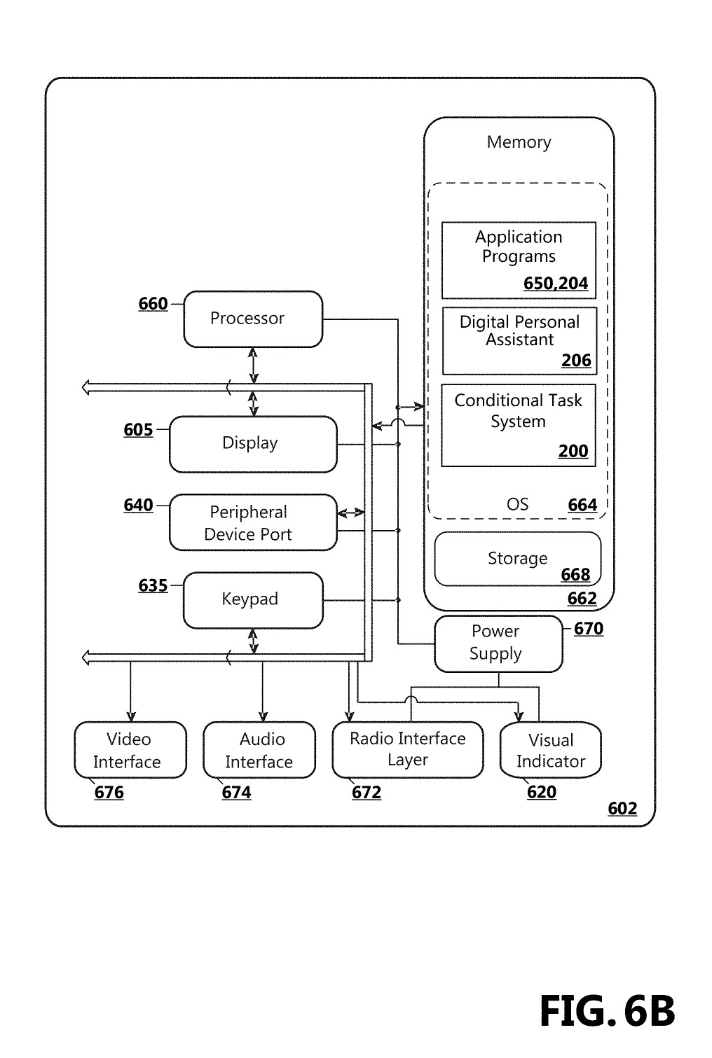

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or less input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650,204 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, the digital personal assistant 206 is loaded into the memory 662 and run on or in association with the operating system 664. According to another aspect, one or more components of the conditional task system 200 are loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668. According to an aspect, data/information generated or captured by the mobile computing device 600 and stored via the system 602 is stored locally on the mobile computing device 600, as described above. According to another aspect, the data is stored on any number of storage media that are accessible by the device via the radio 672 or via a wired connection between the mobile computing device 600 and a separate computing device associated with the mobile computing device 600, for example, a server computer in a distributed computing network, such as the Internet. As should be appreciated such data/information is accessible via the mobile computing device 600 via the radio 672 or via a distributed computing network. Similarly, according to an aspect, such data/information is readily transferred between computing devices for storage and use according to well-known data/information transfer and storage means, including electronic mail and collaborative data/information sharing systems.

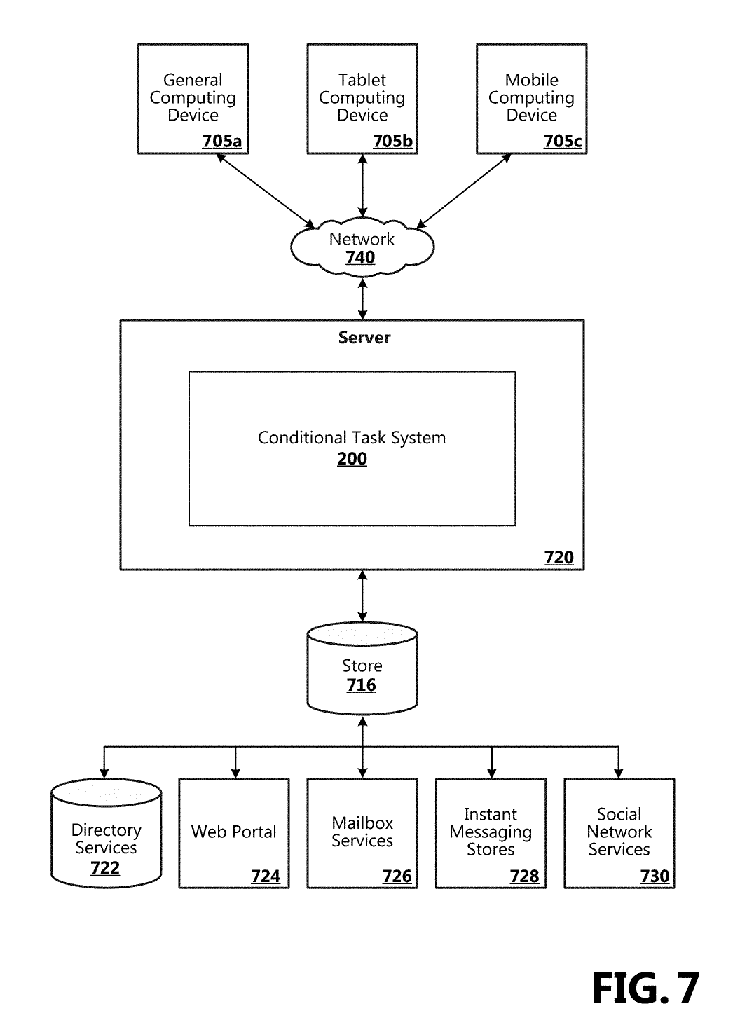

FIG. 7 illustrates one example of the architecture of a system for providing automatic extraction and application of conditional tasks from content as described above. Content developed, interacted with, or edited in association with the one or more components of the conditional task system 200 are enabled to be stored in different communication channels or other storage types. For example, various documents may be stored using a directory service 722, a web portal 724, a mailbox service 726, an instant messaging store 728, or a social networking site 730. One or more components of the conditional task system 200 are operative or configured to use any of these types of systems or the like for providing computing device state or activity based task reminders and automatic tracking of statuses of task-related activities, as described herein. According to an aspect, a server 720 provides the one or more components of the conditional task system 200 to client computing devices 705a,b,c. As one example, the server 720 is a web server providing one or more components of the conditional task system 200 over the web. The server 720 provides one or more components of the conditional task system 200 over the web to clients 705 through a network 740. By way of example, the computing device is implemented and embodied in a personal computer computing device 705a, a tablet computing device 705b or a mobile computing device 705c (e.g., a smart phone), or other computing device. Any of these examples of the computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

1. A system for providing automatic extraction and application of conditional tasks from content, the system comprising:
at least one processing device; and
at least one computer readable data storage device storing instructions that, when executed by the at least one processing device, cause the system to:
receive a content item, the content item comprising a task specifying a task action;
upon identifying a trigger condition and the task action of the task, determine that the task is a conditional task;
identify a condition actor;
monitor the condition actor for determining whether the trigger condition has been satisfied; and
when a determination is made that the trigger condition has been satisfied, engage a task action actor associated with the conditional task.

2. The system of claim 1, wherein the content item is comprised of one or more natural language phrases and is one of:
a communication item;
a string of communication items;
a document;
a calendar item;
a task item; or
a meeting transcript.

3. The system of claim 1, wherein in identifying the condition actor, the system is further configured to:
identify and extract, from the conditional task, entities relevant to the trigger condition;
determine, from the entities relevant to the trigger condition, a trigger condition intent;
classify the trigger condition based on the trigger condition intent; and
based on the classification of the trigger condition, identify the condition actor.

4. The system of claim 3, wherein, based on the classification of the trigger condition, the system is further configured to identify at least one condition argument, wherein data provided in response to the at least one condition argument comprises information for determining whether the trigger condition has been satisfied.

5. The system of claim 3, wherein the system is further configured to:
identify and extract, from the conditional task, entities relevant to the task action;
determine, from the entities relevant to the task action, a task action intent;
classify the task action based on the task action intent; and
based on the classification of the task action, identify a task action actor.

6. The system of claim 5, wherein in engaging the task action actor associated with the conditional task, the system is further configured to engage the task action actor to perform the task action or to initiate the task action on behalf of a user associated with the conditional task.

7. The system of claim 5, wherein in engaging the task action actor associated with the conditional task, the system is further configured to engage a task action actor embodied as a notification engine to provide a notification to a user associated with the conditional task, the notification reminding the user of the task action.

8. The system of claim 5, wherein in engaging the task action actor associated with the conditional task, the system is further configured to engage a task action actor embodied as a task list application to indicate one or more pending tasks in a graphical user interface, wherein a pending task is a conditional task in which the trigger condition has been determined to be satisfied.

9. The system of claim 1, wherein in engaging the task action actor, the system is further configured to engage the task action actor based on one or more learned or user-set engagement parameters, the engagement parameters defining how and when to engage a user associated with the conditional task.

10. The system of claim 1, wherein the system is further configured to:
receive implicit or explicit user feedback, the user feedback associated with one or a combination of an individual user, a cohort, and a population;
determine user preferences based on the user feedback; and
tune, based on the user feedback, models associated with identifying and extracting entities relevant to the trigger condition and models associated with identifying and extracting entities relevant to the task action.

11. A computer-implemented method for providing automatic extraction and application of conditional tasks from content, the method comprising:
receiving a content item, the content item comprising a task specifying a task action;
upon identifying a trigger condition and the task action of the task, determining that the commitment is a conditional task;
identifying a condition actor;
monitoring the condition actor for determining whether the trigger condition has been satisfied; and
when a determination is made that the trigger condition has been satisfied, engaging a task action actor associated with the conditional task based on one or more learned or user-set engagement parameters, the engagement parameters defining how and when to engage a user associated with the conditional task.

12. The method of claim 11, wherein identifying the trigger condition comprises identifying an explicit trigger condition or identifying an implicit trigger condition based on past user interactions.

13. The method of claim 11, wherein engaging the task action actor associated with the conditional task comprises engaging the task action actor to perform the task action or initiating the task action on behalf of a user associated with the conditional task.

14. The method of claim 11, wherein engaging the task action actor associated with the conditional task comprises:
engaging a task action actor embodied as a notification engine to provide a notification to a user associated with the conditional task, the notification reminding the user of the task action; or
engaging a task action actor embodied as a task list application to indicate one or more pending tasks in a graphical user interface, wherein a pending task is a conditional task in which the trigger condition has been determined to be satisfied.

15. The method of claim 11, wherein identifying the condition actor further comprises:
identifying and extracting, from the conditional task, entities relevant to the trigger condition;
determining, from the entities relevant to the trigger condition, a trigger condition intent;
classifying the trigger condition based on the trigger condition intent; and
based on the classification of the trigger condition, identifying the condition actor.

16. The method of claim 15, further comprising, based on the classification of the trigger condition, identifying at least one condition argument, wherein data provided in response to the at least one condition argument comprises information for determining whether the trigger condition has been satisfied.

17. The method of claim 15, further comprising:
identifying and extracting, from the conditional task, entities relevant to the task action;
determining, from the entities relevant to the task action, a task action intent;
classifying the task action based on the task action intent; and
based on the classification of the task action, identifying the task action actor.

18. The method of claim 11, further comprising:
receiving implicit or explicit user feedback, the user feedback associated with one or a combination of an individual user, a cohort, and a population;
determining user preferences based on the user feedback; and
tuning, based on the user feedback, models associated with identifying and extracting entities relevant to the trigger condition and models associated with identifying and extracting entities relevant to the task action.

19. A computer readable storage device including computer readable instructions, which when executed by a processing unit the processing unit is configured to:
receive a communication item;
identify, in the communication item, a task specifying a task action;
upon identifying a trigger condition and the task action of the task, determine that the task is a conditional task;
identify and extract, from the conditional task, entities relevant to the trigger condition;
determine, from the entities relevant to the trigger condition, a trigger condition intent;
classify the trigger condition based on the trigger condition intent;
based on the classification of the trigger condition, identify a condition actor;
monitor the condition actor for determining whether the trigger condition has been satisfied;
identify and extract, from the conditional task, entities relevant to the task action;
determine, from the entities relevant to the task action, a task action intent;
classify the task action based on the task action intent;
based on the classification of the task action, identify a task action actor; and
when a determination is made that the trigger condition has been satisfied, engage the task action actor associated with the conditional task.

20. The computer readable storage device of claim 19, wherein in engaging the task action actor, the processing unit is further configured to:
engage the task action actor to perform the task action or to initiate the task action on behalf of a user associated with the conditional task;
engage a task action actor embodied as a notification engine to provide a notification to a user associated with the conditional task, the notification reminding the user of the task action; or
engage a task action actor embodied as a task list application to indicate one or more pending tasks in a graphical user interface, wherein a pending task is a conditional task in which the trigger condition has been determined to be satisfied.
